(19) United States
(12) Patent Application Publication
(10) Pub. No.: US 2019/0066081 A1
(43) Pub. Date: Feb. 28, 2019

(54) SELF-SERVICE POINT OF SALE DEVICE AND METHOD OF CONTROLLING THE SAME

(71) Applicant: TOSHIBA TEC KABUSHIKI KAISHA, Tokyo (JP)

(72) Inventor: Yukiyoshi YAMAZAKI, Gotemba Shizuoka (JP)

(21) Appl. No.: 16/109,007

(22) Filed: Aug. 22, 2018

(30) Foreign Application Priority Data
Aug. 24, 2017 (JP) 2017-161300

(51) Int. Cl. G06Q 20/20

(52) U.S. Cl. CPC G06Q 20/209; G06Q 20/202; G06Q 20/208

(57) ABSTRACT

According to an embodiment, a self-service point of sale device is provided in a store. An input device receives, from a user, input of merchandise information corresponding to merchandise to be purchased in a current transaction. A memory stores an error count in connection with the current transaction. A processor performs a registration and accounting processing for the current transaction based on the received input of merchandise information and received payment information. The processor determines when the user performs an operation error in connection with the registration and accounting processing, and increments the error count when the user is determined to perform the operation error. The processor determines whether the error count exceeds a predetermined amount, and when the error count exceeds the predetermined amount, controls an output device to output an alert recommending that the user use a manned cash register in the store for a future transaction.

### CROSS-REFERENCE TO RELATED APPLICATION

This application is based upon and claims the benefit of priority from Japanese Patent Application No. 2017-161300, filed on Aug. 24, 2017, the entire contents of which are incorporated herein by reference.

### FIELD

Embodiments described herein relate generally to a self-service point of sale device and a method of controlling the same.

### BACKGROUND

In the related arts, retail stores such as supermarkets and convenience stores may be provided with a self-checkout device, through which customers register and perform payment, in addition to a manned cash register through which a cashier registers and handles payment. When the manned cash register and the self-checkout device (for example, a self-service point of sale (POS) device) are provided together in this way, the time to wait for registration can be shortened, and reduction in the burden on a person in charge of the register or reduction in personnel expenses can be achieved.

However, the operation of the self-service POS device is not easy for everyone. A customer, for example, may not be good at operating the machine, or may hardly understand the operation method, or may make frequent mistakes even when the guidance is displayed. For this reason, such a customer may frequently call attendants who are support personnel. As for the store side, it is considered more efficient and preferable for such customers to use the manned cash register instead of the self-service POS device. That is, when the customers who frequently make mistakes are urged to use the manned cash register, the efficiency of the store as a whole regarding registration and accounting for customers can be improved.

### DESCRIPTION OF THE DRAWINGS

FIG. 1 is a block diagram illustrating a configuration of a store system according to an exemplary embodiment;

FIG. 2 is an external perspective view of a self-service POS device;

FIG. 3 is a block diagram illustrating a functional configuration of the self-service POS device;

FIG. 4 illustrates an example of a registration screen;

FIG. 5 illustrates an example a notification screen;

FIG. 6 illustrates a printing example of a receipt;

FIG. 7 is a block diagram illustrating an example of a hardware configuration of a store server;

FIG. 8 illustrates an example of a data configuration of a member database;

FIG. 9 is a block diagram illustrating an example of a hardware configuration of an attendant terminal;

FIG. 10 illustrates an example of an alert displayed on an attendant terminal;

FIGS. 11 and 12 are sequence diagrams illustrating a registration processing in the store system; and

FIG. 13 illustrates an example of an alert displayed on the registration screen.

### DETAILED DESCRIPTION

Embodiments provide a self-service point of sale device capable of improving the efficiency of the store as a whole regarding registration and accounting for customers, and a method of controlling the self-service point of sale device.

According to an embodiment, a self-service point of sale device is provided in a store. An input device receives, from a user, input of merchandise information corresponding to merchandise to be purchased in a current transaction. A memory stores an error count in connection with the current transaction. A processor is programmed to perform a registration and accounting processing for the current transaction based on the received input of merchandise information and payment information received from the user. The processor determines when the user performs an operation error in connection with the registration and accounting processing, and increments the error count when the user is determined to perform the operation error. The processor determines whether the error count exceeds a predetermined amount, and when the error count exceeds the predetermined amount, controls an output device to output an alert recommending that the user use a manned cash register in the store for a future transaction.

A store system of an exemplary embodiment will be described below with reference to the drawings. The self-checkout system (hereinafter, referred to as self-service POS device) of the embodiment is installed and used in a store such as a supermarket.

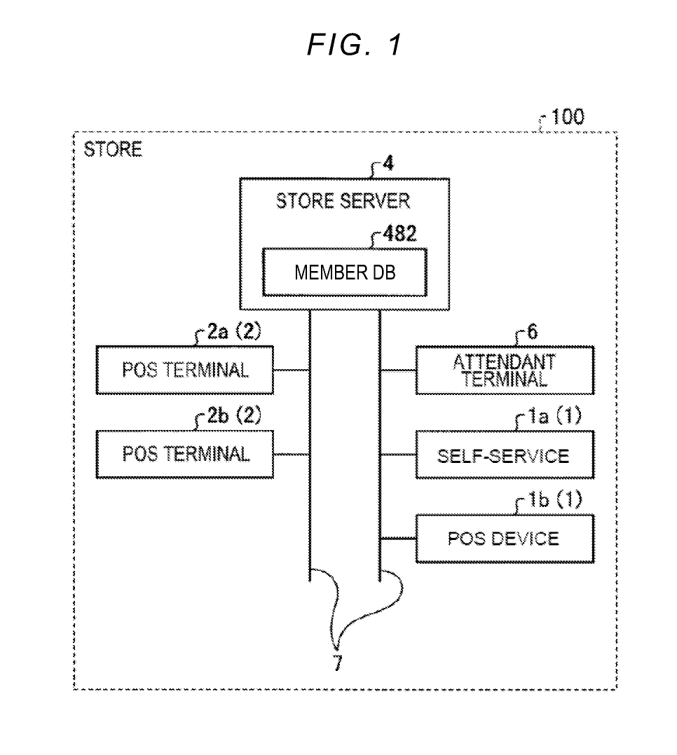

FIG. 1 is a block diagram illustrating a configuration of a store system 100 according the embodiment. As illustrated in FIG. 1, a plurality of POS terminals 2 (2a, 2b . . . ) which are manned cash registers and a plurality of self-service POS devices 1 (1a, 1b . . . ) are installed in a store. Each of the terminals is connected to a store server 4. The POS terminals 2 and the self-service POS devices 1 access a member database (DB) 482 of the store server 4 through a connection line such as a local area network (LAN) 7, and request member information and points. As another form, assuming that a member server manages members of a plurality of stores, and manages data equivalent to the member database 482, the POS terminal 2 and the self-service POS device 1 may access a member server outside the store through a dedicated line or the like to access the data equivalent to the member database 482.

In addition, the self-service POS devices 1 (1a, 1b . . . ) are respectively connected to attendant terminals 6 through LANs 7. The attendant terminal 6 is an information processing terminal for assisting a user of the self-service POS device 1, and notifies attendants (assistant clerks) of a corresponding situation by issuing an alert when a clerk call or an error occurs in the self-service POS device 1.

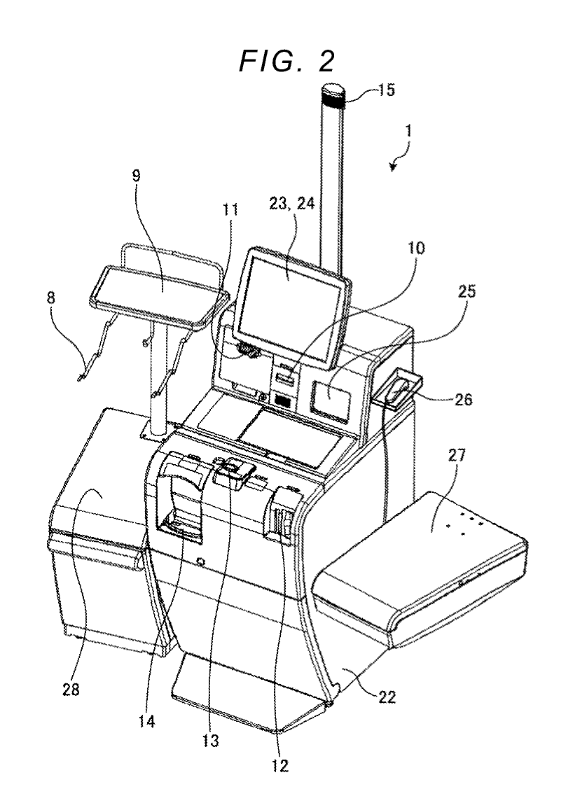

FIG. 2 is an external perspective view of the self-service POS device 1 according to the embodiment. A main body 22 of the self-service POS device 1 includes a display 24, a scanner 25 (a scanner 25 of the main body 22), and a hand scanner 26. On the front surface of the display 24, a touch panel 23 is provided.

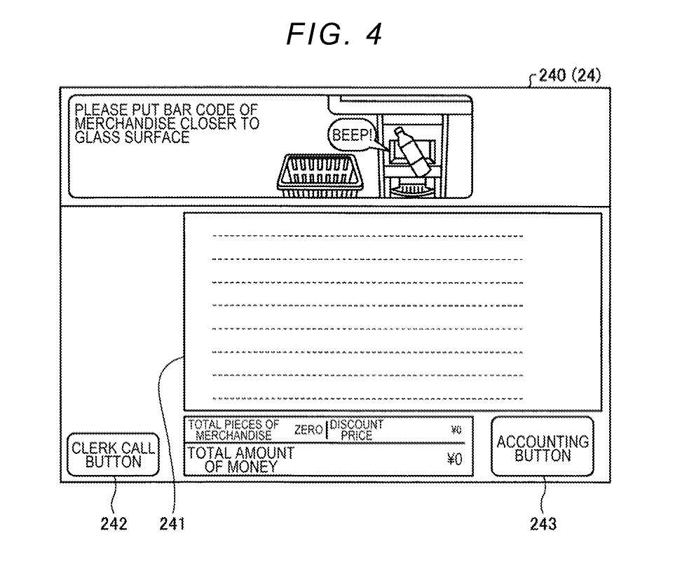

As the display 24, for example, a liquid crystal display may be used. The display 24 displays a guidance screen for informing a customer of an operation method of the self-service POS device 1. Further, the display 24 displays an input screen for inputting information for merchandise to which no code symbol is attached. In addition, the display 24 displays a registration screen 240 (see FIG. 4) for displaying merchandise information read by the scanner 25 or the hand scanner 26. The display 24 displays a total amount of money, a prepayment amount of money, and a change amount, and displays an accounting screen or the like for selecting a payment method.

The scanner 25 and the hand scanner 26 read a code symbol such as a bar code or a two-dimensional code attached to merchandise. Further, the scanner 25 or the hand scanner 26 reads a code symbol displayed on a customer's portable electronic device. The scanner 25 includes an optical image capturing element, and captures an image of an imaging region in front of the reading window. The customer holds the code symbol attached to the merchandise or the display of the portable electronic device over the reading window of the scanner 25, so that the scanner 25 reads the code symbol. However, the customer cannot hold a code symbol attached to large-sized merchandise such as a cardboard box or a long-sized item over the reading window of the scanner 25. In this case, the customer may scan the code symbol with the hand scanner 26.

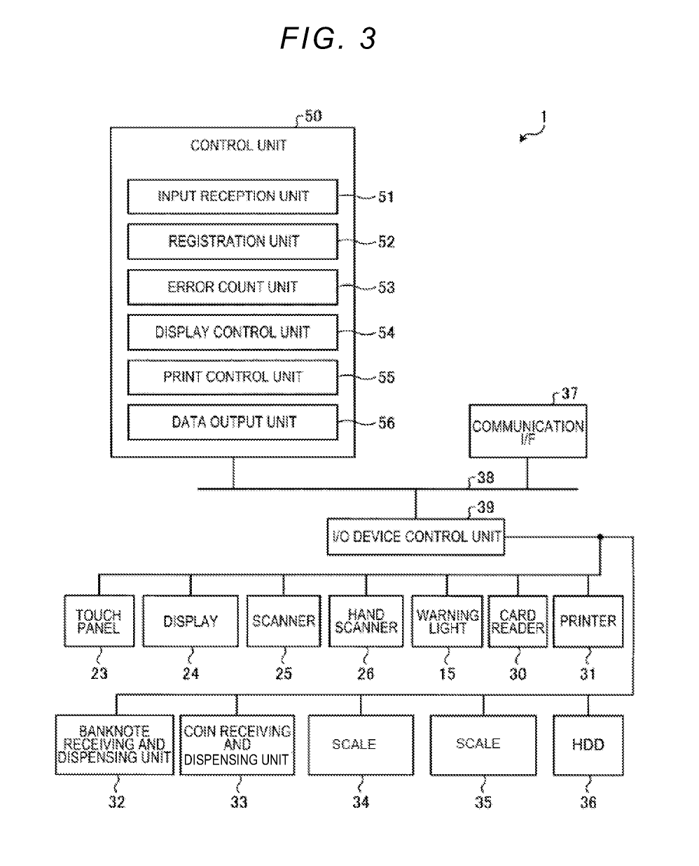

A merchandise placing table 27 is provided on the right side of the main body 22 to place the unregistered merchandise present in a shopping bag. Further, a merchandise placing table 28 is provided on the left side of the main body 22 to place the registered merchandise. In addition, a bag hook 8 for hanging a bag containing the registered merchandise and a temporary table 9 for temporarily placing the registered merchandise before the registered merchandise is placed into the bag are provided. The merchandise placing table 27 includes a scale 34 (see FIG. 3), and the merchandise placing table 38 includes a scale 35 (see FIG. 3). If the total weight of the merchandise is different by a predetermined level or more before and after the reading, the self-service POS device 1 outputs an error.

The main body 22 of the self-service POS device 1 is provided with a card insertion slot 10 into which a point card and a credit card of the customer is inserted at the time of payment. Further, the main body 22 is provided with a receipt issuing port 11 used for issuing a receipt. In addition, the main body 22 is provided with a banknote receiving and dispensing port 12 used for depositing banknotes for payment and receiving banknotes for change. In addition, the main body 22 is provided with, for example, a coin slot 13 used for inputting coins at the time of payment and a coin outlet 14 used for receiving coins for change. Further, a pole is provided on an upper surface of the main body 22. On an upper part of the pole, a warning light 15 is provided which is turned on when an operation abnormality occurs in the self-service POS device 1 or the customer calls a clerk.

A functional configuration of the self-service POS device 1 will be described below. FIG. 3 is a block diagram illustrating a functional configuration of the self-service POS device 1. The self-service POS device 1 includes a control unit 50 as a component of a computer including a Central Processing Unit (CPU), a Read Only Memory (ROM), and a Random Access Memory (RAM) (neither is illustrated in the drawing). The ROM stores various programs executed by the CPU and various types of data. The RAM stores temporarily data and programs when the CPU executes various programs. In addition, the RAM stores sales data indicating the sales record of merchandise and various types of screen display data to be displayed on the display 24.

The control unit 50 is connected to I/O (Input/Output) devices such as the touch panel 23, the display 24, the scanner 25, the hand scanner 26, the warning light 15, a card reader 30, a printer 31, a banknote receiving and dispensing unit 32, a coin receiving and dispensing unit 33, the scale 34, the scale 35, and a Hard Disk Drive (HDD) 36 through an I/O device control unit 39 and a bus 38. The control unit 50 controls the operation of each unit, and controls the entire system of the self-service POS device 1. Further, the control unit 50 communicates with the store server 4 and the attendant terminal 6 (see FIG. 1, respectively) connected to each other by the LAN 7, through a communication I/F 37.

The card reader 30 reads information on a customer's point card or credit card inserted from the card insertion slot 10. The printer 31 prints the receipt after the accounting, and issues the printed receipt from the receipt issuing port 11. The banknote receiving and dispensing unit 32 processes the banknote inserted or discharged from the banknote receiving and dispensing port 12. The coin receiving and dispensing unit 33 performs a process when a coin is inserted from the coin slot 13 and a process when a coin is discharged to the coin outlet 14.

A program executed by the self-service POS device 1 of the embodiment will be described below. The program executed by the self-service POS device 1 of the embodiment is embedded in a ROM or the like in advance. The program executed by the self-service POS device 1 of the embodiment may be recorded on a computer readable recording medium such as a CD-ROM, a flexible disk (FD), a compact disc recordable (CD-R), and a digital versatile disk (DVD) in an installable format or an executable format file.

The program executed by the self-service POS device 1 of the embodiment may be stored in a computer connected to a network such as the Internet and may be downloaded via the network. Further, the program executed by the self-service POS device 1 of the embodiment may be provided or distributed via a network such as the Internet.

As illustrated in FIG. 3, the program executed by the self-service POS device 1 of the embodiment has a module configuration including an input reception unit 51, a registration unit 52, an error count unit 53, a display control unit 54, a print control unit 55, and a data output unit 56. As an actual hardware, the units described above are loaded on a main memory device when the CPU (processor) reads and executes the program of the embodiment from the ROM. Consequently, the input reception unit 51, the registration unit 52, the error count unit 53, the display control unit 54, the print control unit 55, and the data output unit 56 are implemented by the CPU and the main memory device.

The input reception unit 51 receives input operations and input data with respect to input devices such as the touch panel 23, the scanner 25, the hand scanner 26, and the card reader 30. Further, when the user scans a membership card with the card reader 30 at the time of using the self-service POS device 1, the input reception unit 51 receives a member code (member identification information) of the user written in the membership card.

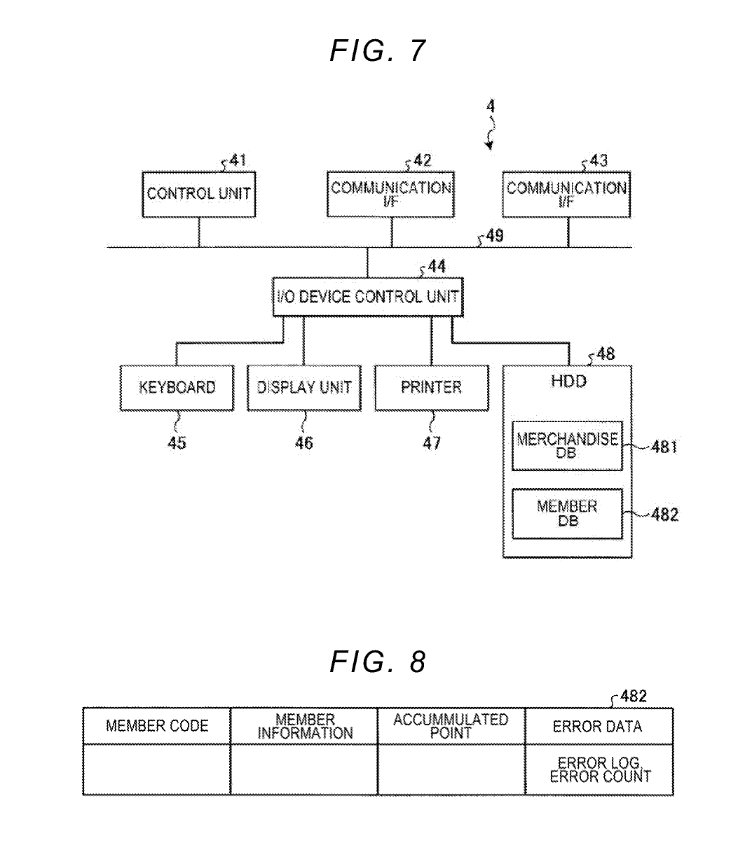

The registration unit 52 registers merchandise for a sales transaction. That is, the registration unit 52 reads merchandise information from a merchandise database (DB) 481 (see FIG. 7) of the store server 4 according to the reception content of the input reception unit 51. In addition, the registration unit 52 calculates the total amount of money for the merchandise, and registers the calculated total amount of money in a sales file in the HDD 36 together with the merchandise information of sales merchandise.

The error count unit 53 (error integrating unit) counts operation errors in the self-service POS device 1 for the user corresponding to the member code received by the input reception unit 51, and stores the operation error count in an error count region of the HDD 36.

For example, when a clerk is called, the error count unit 53 counts the call as an operation error. Incidentally, when the calls are performed more than a predetermined number of times within a reference time, the error count unit 53 may count each of the calls as an operation error. More specifically, the error count unit 53 increments up the number of operation errors when a clerk call button 242 (see FIG. 4) is operated on a registration screen 240 (see FIG. 4) to be described below 242.

In addition, the error count unit 53 determines operation errors when values of the scale 34 and the scale 35 do not coincide with each other before and after scanning of the merchandise with the scanner 25 or the hand scanner 26. That is, when the values of the scales 34 and 35 vary by more than an insignificant amount, the error count unit 53 increments up the number of operation errors.

Further, the error count unit 53 increments up the number of operation errors when the interval of scanning with the scanner 25 or the hand scanner 26, that is, when a non-input time is equal to or longer than a prescribed time.

Besides this, when the non-input operation time with respect to the display on the display 24 is equal to or longer than the prescribed time or when the operation on the banknote receiving and dispensing unit 32 and the coin receiving and dispensing unit 33 is out of a normal operation procedure, the error count unit 53 may increment up the number of operation errors.

Further, when the same user makes many operation errors on the self-service POS device 1, that is, when the count number of operation errors becomes equal to or larger than a predetermined value, the error count unit 53 determines that the error count reaches an alert output level, and instructs the display control unit 54, the print control unit 55, and the data output unit 56 to output the alert.

Incidentally, the count of the operation error may start as a new count for each transaction, or may integrate and count up previous errors corresponding to previous transactions of the same user using the member code.

Whether the number of error counts reaches the alert output level may be determined by comparison of the stored value of the operation errors with a reference value, or may be determined by comparison of an error frequency with a reference value of the error frequency. The error frequency may be obtained by calculation of the number of errors per unit time, or may be obtained by calculation of the number of errors per piece of merchandise using the number of pieces of merchandise.

The display control unit 54 controls the display on the display 24. As an example, the display control unit 54 displays the registration screen 240 (see FIG. 4), which is used for registering the merchandise, on the display 24.

FIG. 4 is a diagram illustrating an example of the registration screen 240. The display control unit 54 reads the merchandise information on the merchandise code received by the input reception unit 51 from the merchandise database 481 (see FIG. 7) of the store server 4, and displays the merchandise information on a registration merchandise display area 241 of the registration screen 240. The registration screen 240 is provided with the clerk call button 242 used for calling a clerk and an accounting button 243 used for proceeding to accounting after finishing the scanning. The input reception unit 51 transmits a call notification to the attendant terminal 6 when receiving the operation of the clerk call button 242.

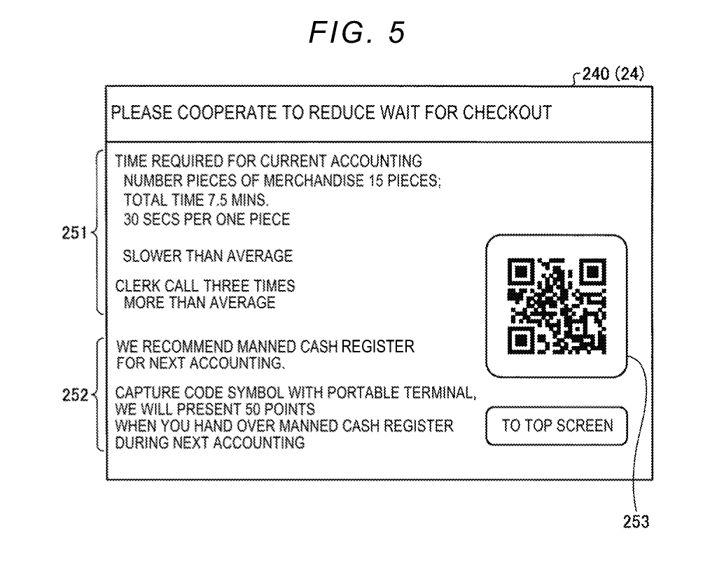

Further, the display control unit 54 (alert output unit) outputs an alert—recommending that the user uses the manned cash register—for display on the display 24 when the same user makes too many operation errors on the self-service POS device 1, that is, when the number of error counts reaches the alert output level. Although the timing of the alert output is not limited, as an example, the display control unit 54 may display an alert message on a notification screen 250 (see FIG. 5) when the accounting for the current transaction is completed. With such timing, it is possible to call attention when the user concludes the operation for the time being and waits for the receipt to be issued.

FIG. 5 is a diagram illustrating an example of the notification screen 250. On the notification screen 250, for example, an operation result 251 is displayed based on the count number of operation errors. As the operation result 251, a total time required for the operation of one transaction and an operation time per piece are displayed as illustrated in FIG. 5. In addition, as illustrated in FIG. 5, the speed of the operation may be displayed as “slow”, “normal”, and “quick” when compared with an average value. As illustrated in FIG. 5, the number of times of clerk calling in one transaction may be displayed based on the number of times of the operation of the clerk call button 242, and the frequency of calls may be displayed as “more”, “normal”, and “less” when compared with an average value. Although not illustrated, for the number of times and the frequency of other operation errors, the number of times and the comparison with the average value may be displayed. The comparison with the average value may be performed based on error data accumulated in the HDD 36 of the self-service POS device 1 or an HDD 48 (see FIG. 7) of the store server 4.

Further, as illustrated in FIG. 5, the alert message 252 is displayed on the notification screen 250 recommending the use of the manned cash register in the next and subsequent accounting. In addition, as the content of the alert message 252, a message may indicate that a bonus point will be given as illustrated in FIG. 5 when the next and subsequent accounting is performed in the manned cash register. By giving the bonus, it is possible to motivate the user to use the POS terminal 2, which is the manned cash register, rather than the self-service POS device 1.

In the notification screen 250, a code symbol 253 usable at the time of next and subsequent accounting may be included. For example, information indicating a bonus point to be given to a user is encoded in the code symbol 253. The user performs accounting at the POS terminal 2, which is the manned cash register, at the time of next and subsequent accounting, and holds the code symbol 253 over a scanner (not illustrated) of the POS terminal 2. The POS terminal 2 decodes the code symbol 253, and adds the bonus point to the user's point total.

The print control unit 55 (see FIG. 3) generates print data of the receipt using the registration data by the registration unit 52, the data on the operation errors counted by the error count unit 53, and the information read from the member database 482, and outputs the print data to the printer 31. The printer 31 prints out the receipt based on the print data. Further, the print control unit 55 (alert output unit) outputs the alert (recommending that the user use the manned cash register) to be printed on the receipt when the user makes too many operation errors on the self-service POS device 1.

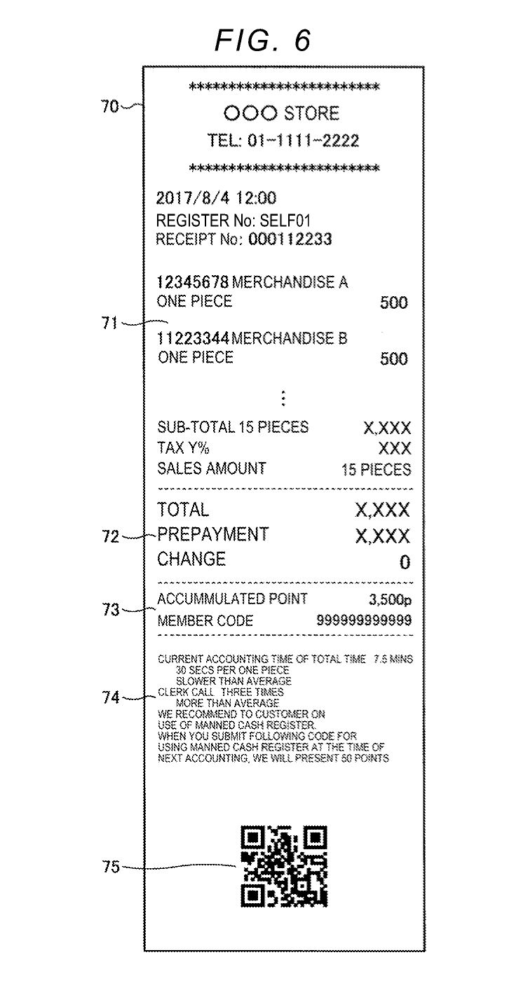

FIG. 6 is a diagram illustrating a printing example of a receipt 70. As illustrated in FIG. 6, the print data on the receipt 70 includes a transaction date, a register number (register No.) which is identification information of the self-service POS device 1, a receipt number (receipt No.), and transaction information 71 including merchandise information registered by the registration unit 52. On the receipt 70, accounting information 72 such as a total amount of money, a prepayment amount of money, and a change amount of money is printed. On the receipt 70, point information 73 such as a member code and an accumulated point amount is also printed. In addition, an alert message 74 and a code symbol 75 are printed on the receipt 70. The alert message 74 has the same configuration as the alert message 252 illustrated in FIG. 5, and the code symbol 75 has the same configuration as the code symbol 253 illustrated in FIG. 5.

When the alert message 74 is printed on the receipt 70 in this manner, the user of the self-service POS device 1 can confirm the recommendation message concerning use of the manned cash register from the receipt 70 issued after the accounting. The user can also confirm thoroughly the contents of information on the bonus from the issued receipt 70. When the code symbol 75 is printed on the receipt 70, the bonus point can be automatically given by the POS terminal 2 in the store at the time of next accounting.

When the clerk call button 242 is operated, the data output unit 56 (see FIG. 3) outputs the identification information (for example, the register number and the register name) of the self-service POS device 1 and the notification that the call has occurred in the self-service POS device 1, to the attendant terminal 6 connected to the self-service POS device 1.

In addition, the data output unit 56 outputs, to the attendant terminal 6, the identification information (for example, the register number and the register name) of the self-service POS device 1 and the alert notification when the number of error counts reaches the alert output level as described above. As the alert notification, information indicating that the user of the self-service POS device 1 is in a caution-needed state is used.

Further, the data output unit 56 outputs data of the error count as well as merchandise registration data of the transaction to the store server 4. The store server 4 stores the received data in the member master 482.

The store server 4 will be described below.

FIG. 7 is a block diagram illustrating an example of a hardware configuration of the store server 4. The store server 4 includes a control unit 41 having a computer configuration including a CPU, a ROM, and a RAM. In addition, the control unit 41 is connected to a keyboard 45, a display unit 46, and printers 47 and HDD 48 through a bus 49 and an I/O device control unit 44. The control unit 41 performs data communication with the self-service POS device 1, the POS terminal 2, and the attendant terminal 6 through a communication I/F 42 and a LAN 7. Further, the control unit 41 performs data communication with a headquarter server, which supervises chain stores, through the communication I/F 43 and a dedicated line. The HDD 48 stores various data files such as a merchandise database (DB) 481, a member database (DB) 482, a sales data file (not illustrated) in addition to various control programs for operating the CPU of the control unit 41.

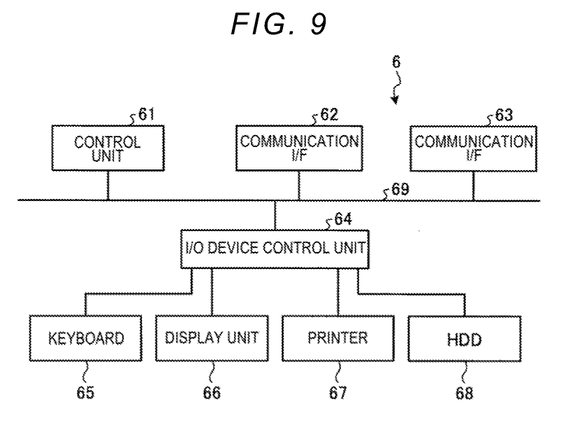

FIG. 8 is a diagram illustrating an example of a data configuration of the member database 482. The member master 482 stores member information, accumulated points, and error data in correlation with each member code that is identification information of a member. The member information is information such as a member name and contact address. The error data stores error data transmitted and output by the data output unit 56 of the self-service POS device 1. Examples of the error data to be stored include an error log in which errors are logged in time series and an error count which is the number of accumulated operation errors.

The attendant terminal 6 will be described below.

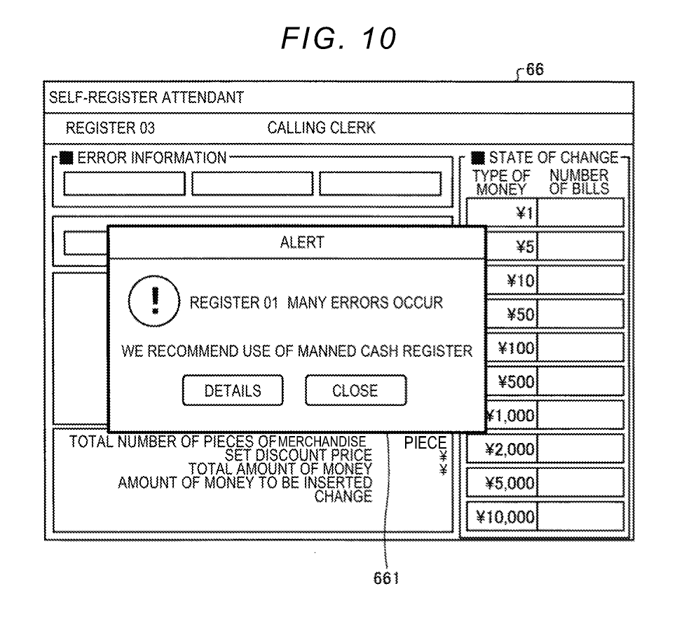

FIG. 9 is a block diagram illustrating an example of a hardware configuration of the attendant terminal 6. The attendant terminal 6 includes a control unit 61 having a computer configuration including a CPU, a ROM, and a RAM. In addition, the control unit 61 is connected to a keyboard 65, a display unit 66, a printer 67, and an HDD 68 through a bus 69 and an I/O device control unit 64. The control unit 61 performs data communication with the self-service POS device 1 through the communication I/F 62 and the LAN 7. Further, the control unit 61 performs data communication with the store server 4 through the communication I/F 63 and the LAN 7.

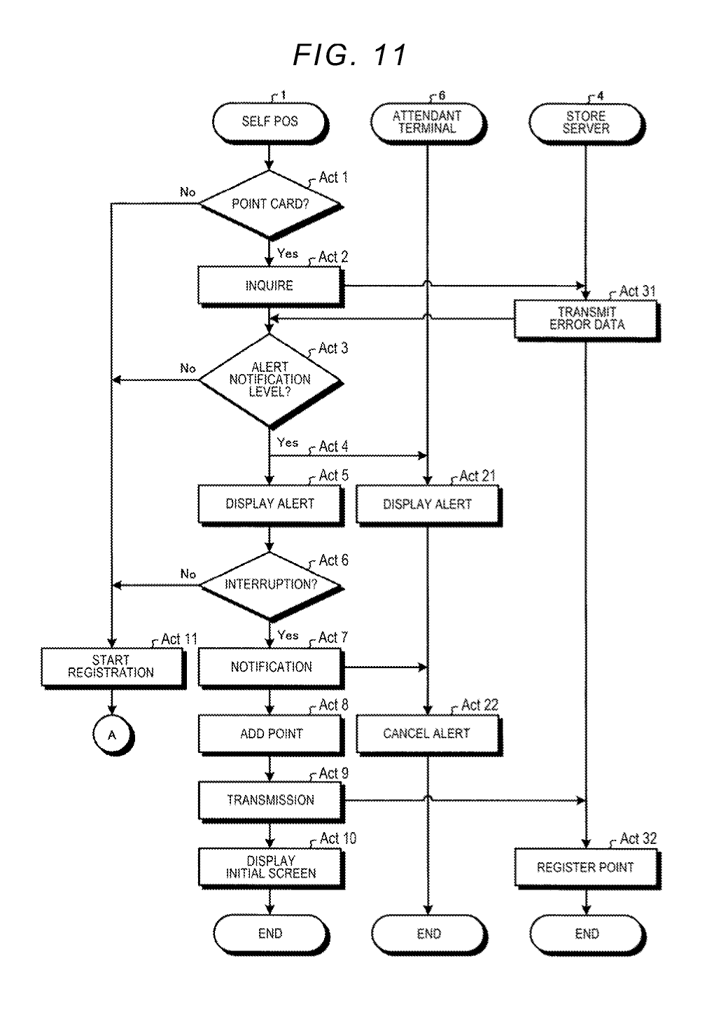

FIG. 10 is a diagram illustrating an example of an alert display on the attendant terminal 6. The control unit 61 of the attendant terminal 6 outputs an alert screen 661 to be displayed on the display unit 66. The alert screen 661 displays, for example, a register number indicated as identification information of the self-service POS device 1 and a message indicating “frequent occurrence of errors” and indicating that the user of the self-service POS device 1 is in the caution-needed state. Further, the alert screen 661 displays a message such as “recommend use of the manned cash register”. The message informs a clerk (attendant) in charge of the attendant terminal 6 of the fact that it is more efficient for the user to use the manned cash register than to use the self-service POS device 1, while the clerk is watching the state of the user of the self-service POS device 1. The action taken by the attendant may be appropriately specified according to the operation of each store, but, for example, when the alert screen 661 is displayed, the attendant may speak to the user when the transaction of self-POS 1 is completed.

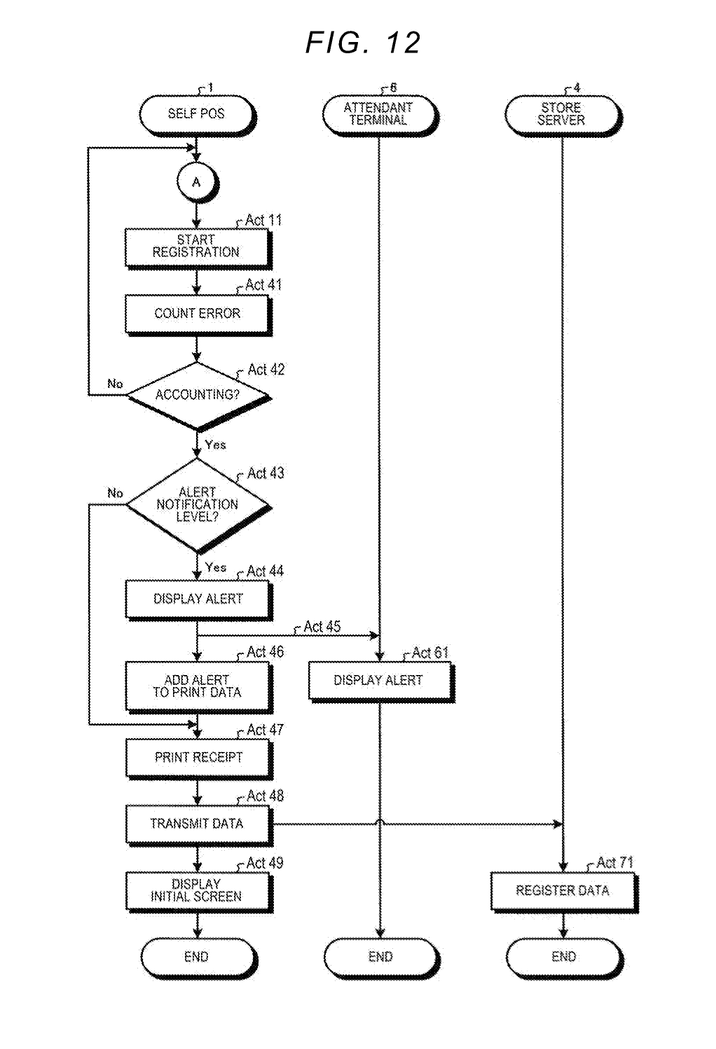

FIGS. 11 and 12 are sequence diagrams illustrating registration processing in the store system 100.

First, a procedure example at the time of reading a point card will be described with reference to FIG. 11. In the sequence of FIG. 11, an example will be described in which the member database 482 stores the error count in association with the member code of the point card. That is, in the following example, it is assumed that the member database 482 stores error counts of each member over a plurality of transactions. In the following example, it is assumed that an alert is output based on the total error value not only after the accounting is finished but also when the use of the self-service POS device 1 is started.

The user of the self-service POS device 1 first reads the point card with the card reader 30. If the user is not a member and does not have a point card (Act 1: No), the process proceeds to Act 11, and the registration unit 52 starts a merchandise registration process. The procedure after the registration process will be described with reference to FIG. 12.

When the card reader 30 reads the member code from the point card (Act 1: Yes), the input reception unit 51 inquires the member code of the store serve 4 (Act 2). The control unit 41 of the store server 4 reads member information, accumulated points, and error data associated with the received member code from the member database 482, and transmits a response to the self-service POS device 1 (Act 31). In the self-service POS device 1, the error count unit 53 determines whether the error count is equal to or greater than a specific value (alert notification level), which is a determination criterion of the alert notification, based on the received error data (Act 3). When the error count is not equal to or greater than the alert notification level (Act 3: No), the process proceeds to Act 11, and the registration unit 52 starts a merchandise registration process (Act 11).

On the other hand, when the error count is equal to or greater than the alert notification level (Act 3: Yes), the data output unit 56 transmits the register number of the self-service POS device 1 and the error data indicating the contents of the alert to the attendant terminal 6 (Act 4). The control unit 61 of the attendant terminal 6 causes the display unit 66 to display the received register number and an alert message indicating that the user of the self-service POS device 1 is an error-prone person and thus is preferred to use the manned cash register (Act 21, see FIG. 10). In addition, the display control unit 54 of the self-service POS device 1 causes the display 24 of the self-service POS device 1 to display an alert message recommending that the user uses the manned cash register (Act 5). The alert message includes a message indicating the intent to provide a bonus point to the user at the time of registering and accounting in the manned cash register 2 instead of the self-service POS device 1.

When the user operates an interruption button or the like through the touch panel 23 according to the alert display and interrupts the registration (Act 6: Yes), the data output unit 56 notifies the register number of the self-service POS device 1 and the interruption of the registration process to the attendant terminal 6 (Act 7). If No in Act 6, the process proceeds to Act 11 to start a registration process. Upon receiving the notification, the control unit 61 of the attendant terminal 6 cancels the alert display displayed in Act 21 (Act 22). Meanwhile, the error count unit 53 of the self-service POS device 1 interrupts the process and adds the bonus point for switching to the manned cash register (Act 8). The data output unit 56 transmits data including the member code and the bonus point to the store server 4 (Act 9). Thereafter, the display control unit 54 displays an initial screen on the display 24 and ends the process for one transaction (Act 10). The control unit 41 of the store server 4 updates the accumulated point of the member master 482 according to the received data (Act 32).

A procedure example after starting the registration process in Act 11 will be described below with reference to FIG. 12. When there is no reading of the point card (Act 1: No), the process proceeds to Act 11, so that it can be said that the procedure illustrated in FIG. 12 indicates an alert output process based on the error count in one registration process (for one transaction) which is not linked with the member database 482.

When the registration unit 52 of the self-service POS device 1 starts registering merchandise (Act 11), the display control unit 54 displays the registration screen 240 on the display 24. The error count unit 53 starts counting operation errors (Act 41).

While the accounting button 243 is not operated on the registration screen 240 (Act 42: No), the process returns to Act 11 to continue the registration process. When the accounting button 243 is operated (Act 42: Yes), the error count unit 53 determines whether the error count reaches the alert notification level (Act 43). When the error count does not reach the alert notification level (Act 43: No), the process proceeds to Act 47. When the error count reaches the alert notification level (Act 43: Yes), the display control unit 54 displays the notification screen 250 (see FIG. 5) on the display 24 (Act 44).

In addition, the data output unit 56 outputs a register number and error information indicating frequent error occurrence to the attendant terminal 6 (Act 45). The control unit 61 of the attendant terminal 6 causes the display unit 66 to display the register number and an alert message recommending that the user of the self-service POS device 1 use the manned cash register due to frequent error occurrence (Act 61).

The print control unit 55 generates print data for the receipt 70 including the transaction information 71, the accounting information 72, the point information 73, the alert message 74, and the code symbol 75 (see FIG. 6) (Act 46). Next, the print control unit 55 prints the receipt 70 (see FIG. 6) with the printer 31, and issues the printed receipt from the receipt issuing port 11 (Act 47).

The data output unit 56 transmits the error count to the store server 4 together with the transaction information 71, the accounting information 72, and the point information 73 (see FIG. 6), as data concerning the transaction (Act 48). The control unit 41 of the store server 4 registers the received data in the member master 482, the sales data file (not illustrated), and the like. Further, the control unit 41 of the store server 4 registers error data associating the transaction date and time with the error count in the member database 482 (see FIG. 8) (Act 71). Thereafter, the display control unit 54 of the self-service POS device 1 switches the display on the display 24 to the initial screen and ends the process of one transaction (Act 49).

As described above, according to the embodiment, when numerous operation errors occurs, the alert recommending the use of the manned cash register is output, so that it is easy to guide a user with many operation errors from the self-service POS device to the manned cash register. That is, for users who impose the burden on the attendant clerk, which takes time to operate, and increase the queue of customers waiting for self-service POS device, it is possible to urge such users to use the manned cash register instead of the self-POS. According to the embodiment, it is possible to improve the efficiency of the store as a whole regarding handling registration and accounting for each customer.

While some embodiments have been described, these embodiments are merely examples, and are not intended to limit the scope of the exemplary embodiment. These novel embodiments may be implemented in various other forms, and various omissions, replacements, and modifications may be made without departing from the scope and spirit of the exemplary embodiment. These embodiments and the modifications are included in the scope and spirit of the exemplary embodiment, and are included in the exemplary embodiment described in the claims and their equivalents.

For example, the functional configuration of the self-checkout system according to the embodiment may be realized on the side of the server device connected to the self-checkout system. That is, the server device may include an error count function, an alert output level determining function, an alert output function, and a data output function, and may be configured to control the display output and the receipt output in the self-service POS device and the attendant terminal.

FIGS. 5 and 6 illustrate the example in which the two-dimensional code is a code symbol. However, the configuration of the code symbol is not limited thereto, and another code symbol such as a bar code may be used.

As an example of the alert output, the example of displaying the alert on the display 24 of the self-service POS device 1, the example of printing out the alert on the receipt 70, and the example of displaying the alert on the display unit 66 of the attendant terminal 6 are described above, but the output destination and the output method are not limited to this. The alert may be output by voice or may be output to the warning light 15, or may be output to other output destinations.

In the above description, the alert is displayed on the notification screen 250 after the accounting is finished, but the timing of the alert display is not limited thereto. The alert may be displayed on the registration screen 240 without waiting for the end of the accounting when the error count reaches the specific value.

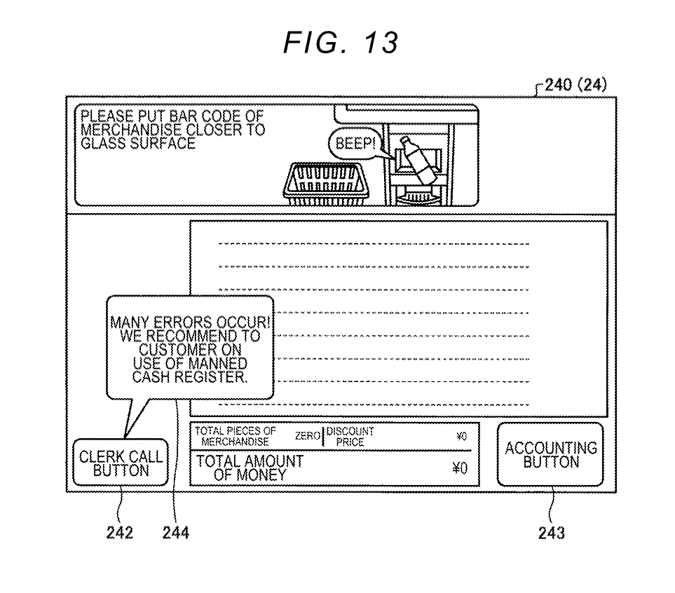

FIG. 13 is a diagram illustrating an example of displaying an alert on the registration screen 240. As an example, the display control unit 54 may display a pop-up error message 244 as illustrated in FIG. 13 when the clerk call button 242 is operated for more than a specified number of times. For the customer who causes frequent errors, a case of interrupting the process even during registration switching to use the manned cash register may be better, and the customer may desire to switch. Therefore, by the output of the alert onto the registration screen 240, it may be recommended that the user under processing uses the manned cash register even during the processing. In addition, the error count is set to two stages of threshold values, the alert may be output after the end of the transaction when the error count reaches the threshold value of the first stage, and the alert may be output immediately when the error count reaches the threshold value of the second stage.

As described above, according to the embodiment, it is possible to improve the efficiency of the store as a whole regarding customer handling in the accounting.

What is claimed is:

1. A self-service point of sale device in a store, the device comprising:
an input device for receiving, from a user, input of merchandise information corresponding to merchandise to be purchased in a current transaction;
a memory that stores an error count in connection with the current transaction;
an output device; and
a processor programmed to:
perform a registration and accounting processing for the current transaction based on the received input of merchandise information and payment information received from the user,
determine when the user performs an operation error in connection with the registration and accounting processing,
increment the error count when the user is determined to perform the operation error,
determine whether the error count exceeds a predetermined amount, and
when the error count exceeds the predetermined amount, control the output device to output an alert recommending that the user use a manned cash register in the store for a future transaction.

2. The device according to claim 1, wherein:
the output device includes a printer, and
the alert includes a message, printed on a receipt printed by the printer, recommending that the user use a manned cash register in the store for the future transaction.

3. The device according to claim 1, wherein:
the output device includes a display, and
the alert includes a message on the display recommending that the user use a manned cash register in the store for the future transaction.

4. The device according to claim 3, wherein:
the output device further includes a communication interface, and
the alert further includes alert information output via the communication interface to an attendant terminal, the alert information causing the attendant terminal to display a message that the user has been recommended to use the manned cash register in the store for the future transaction.

5. The device according to claim 1, wherein:
the input device further receives, from the user, input of member identification information corresponding to the user, and
the processor is further configured to:
retrieve, based on the received member identification information, an accumulated error count performed by the user during registration and accounting processing for previous transactions,
determine whether the accumulated error count exceeds a second predetermined amount,
when the accumulated error count exceeds the predetermined amount, control the output device to output an alert recommending that the user use the manned cash register in the store for the current transaction.

6. The device according to claim 5, wherein:
the processor is further configured to update the accumulated error count to include the error count for the current transaction when the registration and accounting processing for the current transaction is complete.

7. The device according to claim 5, wherein the alert recommending that the user use the manned cash register in the store for the current transaction includes a code that, when scanned at the manned cash register, adds a point value to a point account stored in connection with the received member identification information.

8. The device according to claim 1, further comprising:
a first scale positioned to weigh merchandise before input of the corresponding merchandise information, and
a second scale positioned to weigh merchandise after input of the corresponding merchandise information, wherein
the processor determines that the user performs the operation error in connection with the registration and accounting processing when a first weight measured by the first scale before input of the corresponding merchandise information does not correspond to a second weight measured by the second scale after input of the corresponding merchandise information.

9. The device according to claim 1, further comprising:
a clerk call button for requesting assistance from a clerk,
wherein the processor determines that the user performs the operation error in connection with the registration and accounting processing when the user pushes the clerk call button.

10. The device according to claim 1, wherein:
the processor is further programmed to determine whether an interval during which no merchandise information is received and no payment information is received exceeds a predetermined period, and
the user is determined to perform the operation error in connection with the registration and accounting processing when the interval exceeds the predetermined period.

11. A method of controlling a self-service point of sale device in a store, the method comprising:
receiving, from a user, input of merchandise information corresponding to merchandise to be purchased in a current transaction;
performing a registration and accounting processing for the current transaction based on the received input of merchandise information and payment information received from the user;
determining when the user performs an operation error in connection with the registration and accounting processing;
incrementing an error count for the current transaction when the user is determined to perform the operation error;
determine whether the error count exceeds a predetermined amount; and
when the error count exceeds the predetermined amount, controlling an output device to output an alert recommending that the user use a manned cash register in the store for a future transaction.

12. The method according to claim 11, wherein:
the output device includes a printer, and
the alert includes a message, printed on a receipt printed by the printer, recommending that the user use a manned cash register in the store for the future transaction.

13. The method according to claim 11, wherein:
the output device includes a display, and
the alert includes a message on the display recommending that the user use a manned cash register in the store for the future transaction.

14. The method according to claim 13, wherein:
the output device further includes a communication interface, and
the alert further includes alert information output via the communication interface to an attendant terminal, the alert information causing the attendant terminal to display a message that the user has been recommended to use the manned cash register in the store for the future transaction.

15. The method according to claim 11, further comprising:
receiving, from the user, input of member identification information corresponding to the user;
retrieving, based on the received member identification information, an accumulated error count performed by the user during registration and accounting processing for previous transactions;
determining whether the accumulated error count exceeds a second predetermined amount; and
when the accumulated error count exceeds the predetermined amount, controlling the output device to output an alert recommending that the user use the manned cash register in the store for the current transaction.

16. The method according to claim 15, further comprising:
updating the accumulated error count to include the error count for the current transaction when the registration and accounting processing for the current transaction is complete.

17. The method according to claim 15, wherein the alert recommending that the user use the manned cash register in the store for the current transaction includes a code that, when scanned at the manned cash register, adds a point value to a point account stored in connection with the received member identification information.

18. The method according to claim 15, wherein:
the self-service point of sale device includes a first scale positioned to weigh merchandise before input of the corresponding merchandise information, and a second scale positioned to weigh merchandise after input of the corresponding merchandise information, and
the user is determined to perform the operation error in connection with the registration and accounting processing when a first weight measured by the first scale before input of the corresponding merchandise information does not correspond to a second weight measured by the second scale after input of the corresponding merchandise information.

19. The method according to claim 11, wherein:
the self-service point of sale device includes a clerk call button for requesting assistance from a clerk, and
the user is determined to perform the operation error in connection with the registration and accounting processing when the user pushes the clerk call button.

20. The method according to claim 11, further comprising:
determining whether an interval during which no merchandise information is received and no payment information is received exceeds a predetermined period, wherein
the user is determined to perform the operation error in connection with the registration and accounting processing when the interval exceeds the predetermined period.
